(19) United States
(12) Patent Application Publication
(10) Pub. No.: US 2024/0086805 A1
(43) Pub. Date: Mar. 14, 2024

(54) OPTIMIZATION METHOD AND INFORMATION PROCESSING APPARATUS

(71) Applicant: Fujitsu Limited, Kawasaki-shi (JP)

(72) Inventor: Yoshinobu IIMURA, Kawasaki (JP)

(73) Assignee: Fujitsu Limited, Kawasaki-shi (JP)

(21) Appl. No.: 18/337,251

(22) Filed: Jun. 19, 2023

(30) Foreign Application Priority Data
Sep. 12, 2022 (JP) 2022-144775

(51) Int. Cl. G06Q 10/0631

(52) U.S. Cl. CPC G06Q 10/06315

(57) ABSTRACT

An information processing apparatus calculates, based on result data indicative of a result value for a first demand quantity which arises for a first period, a first profit obtained by optimizing an operation quantity according to the result value, calculates a first prediction value for the first demand quantity by using a trained prediction model, determines, based on a comparison between the first profit and a second profit obtained by optimizing the operation quantity according to a second prediction value obtained by correcting the first prediction value with a correction model, the correction model, and calculates a third prediction value for a second demand quantity which arises for a second period different from the first period by using the prediction model and the correction model and outputs plan data indicative of the operation quantity optimized according to the third prediction value.

### CROSS-REFERENCE TO RELATED APPLICATION

Error! No sequence specified. This application is based upon and claims the benefit of priority of the prior Japanese Patent Application No. 2022-144775, filed on Sep. 12, 2022, the entire contents of which are incorporated herein by reference.

### FIELD

The embodiments discussed herein relate to an optimization method and an information processing apparatus.

### BACKGROUND

Computers optimize operation quantity, such as purchasing or releasing stock resources, according to demand quantity in order to maximize a profit to be obtained. If demand quantity for a target optimization period is unknown, then a computer may predict demand quantity by the use of a machine learning model and design optimum operation quantity with the predicted demand quantity as a premise.

For example, an estimation device which predicts demand quantity for a future period is proposed. This estimation device trains a machine learning model on the basis of demand quantity for a past period and predicts demand quantity for a future period by the use of the trained machine learning model. The estimation device calculates an influence degree indicative of how much fluctuations in the predicted demand quantity influence an expected profit obtained with the predicted demand quantity as a premise. The estimation device retrains the machine learning model by using the calculated influence degree as a weight and predicts demand quantity for the future period again by the use of the retrained machine learning model.

There has been proposed a supply-demand equilibration method. In this method, a customer model which infers a substitution relationship between similar products is generated on the basis of past sales data. In addition, when the balance between supply and demand is lost, an action for minimizing opportunity cost and stock cost is selected. Furthermore, there has been proposed an order quantity determination device which predicts demand quantity of articles for a future period on the basis of demand quantity for a past period and which then makes an order plan that maximizes a profit with the predicted demand quantity as a premise. In addition, there has been proposed a demand prediction device which corrects the number of sold articles for a past period by adding the number of times a sales opportunity is lost due to out of stock and which then trains a machine learning model by the use of corrected sales result data.

See, for example, Japanese Laid-open Patent Publication No. 2018-116700, US Patent Application Publication No. 2015/0066566, Japanese Laid-open Patent Publication No. 2016-91217, and Japanese Laid-open Patent Publication No. 2021-103374.

### SUMMARY

According to an aspect, there is provided a non-transitory computer-readable recording medium storing a computer program that causes a computer to execute a process including: calculating, based on result data indicative of a result value for a first demand quantity which arises for a first period, a first profit obtained by optimizing an operation quantity according to the result value; calculating a first prediction value for the first demand quantity by using a prediction model that has been trained; determining, based on a comparison between the first profit and a second profit obtained by optimizing the operation quantity according to a second prediction value obtained by correcting the first prediction value with a correction model, the correction model; and calculating a third prediction value for a second demand quantity which arises for a second period different from the first period by using the prediction model that has been trained and the correction model and outputting plan data indicative of the operation quantity optimized according to the third prediction value.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a view for describing an information processing apparatus according to a first embodiment;

FIG. 2 illustrates an example of an information processing system according to a second embodiment;

FIG. 3 is a block diagram illustrative of an example of the hardware of a sever apparatus;

FIG. 4 is a graph illustrative of an example of an operation plan based on predicted demand quantity;

FIG. 5 is a block diagram illustrative of an example of the functions of the sever apparatus;

FIG. 6 illustrates an example of a setting table;

FIG. 7 illustrates an example of a result data table;

FIG. 8 illustrates an example of a correction function table;

FIG. 9 is a flow chart illustrative of an example of a procedure for determining an operation plan;

FIG. 10 is a graph illustrative of an example of a comparison between real demand quantity and predicted demand quantity; and

FIG. 11 is a graph illustrative of an example of a comparison between an ideal profit and a predicted profit.

### DESCRIPTION OF EMBODIMENTS

Because there is a limit to prediction accuracy of machine learning models, there may be a difference between predicted demand quantity and real demand quantity. In this case, even if operation quantity planned with the predicted demand quantity as a premise is carried out, it may be that an expected profit is not obtained because of, for example, stock waste caused by excessive stock or opportunity loss caused by stock shortage.

Machine learning models are often trained regardless of importance for optimizing operation quantity so that an error of predicted demand quantity averagely decreases. For example, machine learning models are trained from the viewpoint of increasing a profit so that prediction errors of demand quantity for all hours averagely decreases. In this case, no distinction is made between an hour of great importance and an hour of small importance. Accordingly, when operation quantity is optimized, machine learning models may be retrained in the above way so that a prediction error of demand quantity of great importance becomes preferentially small.

However, retraining a trained machine learning model each time operation quantity is optimized may increase computational complexity or time needed for optimization and lead to inefficiency. Furthermore, retraining a complex machine learning model means that a heavy burden is imposed on a user who uses the trained machine learning model.

Embodiments will now be described by reference to the accompanying drawings.

### First Embodiment

A first embodiment will be described.

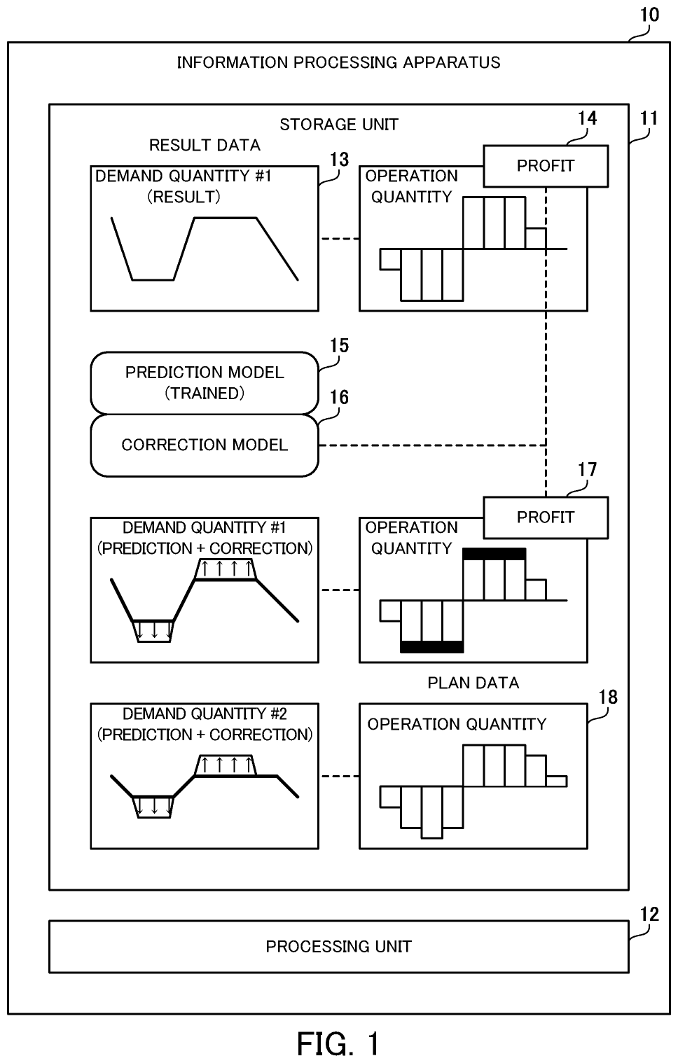

FIG. 1 is a view for describing an information processing apparatus according to a first embodiment.

An information processing apparatus 10 according to a first embodiment predicts demand quantity by the use of a machine learning model and generates a plan for optimum operation quantity corresponding to the predicted demand quantity. The information processing apparatus 10 may be a client apparatus or a server apparatus. The information processing apparatus 10 may be referred to as a computer, an optimization apparatus, or a machine learning apparatus.

The information processing apparatus 10 includes a storage unit 11 and a processing unit 12. The storage unit 11 may be a volatile semiconductor memory, such as a random-access memory (RAM), or nonvolatile storage, such as hard disk drive (HDD) or a flash memory. The processing unit 12 is a processor such as a central processing unit (CPU), a graphics processing unit (GPU), or a digital signal processor (DSP). However, the processing unit 12 may include an electronic circuit such as an application specific integrated circuit (ASIC) or a field programmable gate array (FPGA). The processor executes a program stored in a memory, such as a RAM (or the storage unit 11). A set of processors may be referred to as a multiprocessor or simply a “processor”.

The storage unit 11 stores result data 13. The result data 13 indicate a result value of demand quantity which arises for a first period. The first period is a past period before the time when the following process is performed. The result value may be referred to as real demand quantity. Demand quantity is, for example, consumption of a resource which may be stored in advance and has economic value. Future demand quantity depends on environmental conditions such as weather and an economic state. Therefore, it is difficult to predict future demand quantity without an error. Demand quantity is, for example, consumption of an energy resource, such as electricity, or the sales volume of articles. The result data 13 may include a plurality of result values corresponding to a plurality of hours which belong to the first period. For example, the result data 13 include measured values of power consumption for twenty-four hours.

Furthermore, the storage unit 11 stores a trained prediction model 15. The prediction model 15 is a machine learning model which predicts demand quantity. Machine learning for training the prediction model 15 may be performed by the information processing apparatus 10 or by another information processing apparatus. The prediction model 15 may be trained by the use of the result data 13. There are no limitations to the model structure of the prediction model 15. The prediction model 15 may be a linear regression model or a nonlinear regression model. The prediction model 15 may predict demand quantity from input data, such as air temperature or rainfall, other than demand quantity. In addition, the prediction model 15 may use fluctuations in the latest demand quantity to predict the subsequent demand quantity. For example, the prediction model 15 predicts power consumption from weather information such as air temperature.

The processing unit 12 calculates a prediction value of demand quantity which arises for a second period by the use of the prediction model 15 and optimizes operation quantity according to the calculated prediction value. For example, the second period comes after the first period and may be a future period after the time when the processing unit 12 performs the prediction. The prediction value may be referred to as predicted demand quantity. The operation quantity is, for example, a quantity inputted to and outputted from a stock resource and may be referred to as action quantity. The operation quantity may be the purchase quantity of an energy resource, such as a charge amount to a storage battery, and the discharge quantity of the energy resource, such as a discharge amount from the storage battery. In addition, the operation quantity may be the stocking quantity of articles and the shipping quantity of the articles in stock.

For example, operation quantity is optimized so as to maximize a profit to be obtained. For example, the processing unit 12 plans operation quantity so as to purchase and store an energy resource at an hour when a unit price is low while discharge and consume the stored energy resource at an hour when a unit price is high. This produces a profit resulting from a cost saving. Furthermore, for example, the processing unit 12 plans operation quantity so as to stock and store articles in advance and then ship the articles in stock at an hour when the articles are in great demand. By doing so, a sales profit is obtained. At this time the processing unit 12 optimizes operation quantity on the basis of the prediction value of demand quantity so as to suppress stock waste caused by excessive stock or opportunity loss caused by stock shortage. However, the processing unit 12 does not use the prediction value outputted by the prediction model 15 as it is but uses a corrected prediction value.

First the processing unit 12 calculates, based on the result data 13, a profit 14 obtained by optimizing operation quantity according to a result value. The profit 14 is a maximum profit which could be obtained in the past if there is no prediction error of demand quantity. The profit 14 may be referred to as a maximum achievable profit or an ideal profit. For example, the processing unit 12 searches for optimum operation quantity which maximizes a profit with the result value indicated by the result data 13 as a premise, and calculates a profit corresponding to the optimum operation quantity as the profit 14. The optimum operation quantity may be referred to as ideal operation quantity.

Furthermore, the processing unit 12 calculates a prediction value of demand quantity for the first period, the same period for which the result data 13 indicate a result value of the demand quantity, by the use of the prediction model 15. For example, the processing unit 12 calculates a prediction value of demand quantity for the first period by inputting weather information for the first period to the prediction model 15. The processing unit 12 determines a correction model 16 by the use of the profit 14 and the prediction value for the first period. The correction model 16 corrects a prediction value outputted by the prediction model 15 and may be referred to as a correction function or a machine learning model. Determining the correction model 16 may be referred to as optimization, training, or machine learning. There are no limitations to the model structure of the correction model 16. The correction model 16 may add different correction values according to hours to a prediction value outputted by the prediction model 15.

The processing unit 12 determines the correction model 16 on the basis of a comparison between the profit 14 and a profit 17 obtained by optimizing operation quantity according to a prediction value corrected by the use of the correction model 16. The corrected prediction value may be referred to as post-correction demand quantity. For example, the processing unit 12 determines the correction model 16 so as to minimize the differential between the profit 14 and the profit 17. Metaheuristics, such as genetic algorithm (GA) or particle swarm optimization (PSO), may be used for determining the correction model 16. Furthermore, a steepest descent method may be used for determining the correction model 16. The metaheuristics is heuristics which does not depend on a specific problem.

For example, the processing unit 12 initializes the correction model 16. The processing unit 12 corrects the prediction value outputted by the prediction model 15 by using the correction model 16, searches for optimum operation quantity which maximizes a profit to be obtained with a post-correction prediction value as a premise, and calculates a profit corresponding to the optimum operation quantity as the profit 17. The processing unit 12 updates the correction model 16 so as to narrow the differential between the profit 14 and the profit 17. The processing unit 12 repeats calculating the profit 17 and updating the correction model 16 until a determined convergence condition is satisfied. By doing so, the processing unit 12 determines the correction model 16.

After the processing unit 12 determines the correction model 16, the processing unit 12 uses the prediction model 15 and the correction model 16 to calculate a post-correction prediction value of demand quantity which arises for the second period. For example, the processing unit 12 calculates a pre-correction prediction value by inputting weather information for the second period to the prediction model 15 and calculates a post-correction prediction value by inputting the pre-correction prediction value to the correction model 16. Data for the second period inputted to the prediction model 15 may be forecast data such as weather forecast information. The prediction model 15 and the correction model 16 may be considered as a single machine learning model in which the correction model 16 is concatenated to the prediction model 15 at the subsequent stage.

The processing unit 12 generates plan data 18 indicative of operation quantity optimized according to the post-correction prediction value and outputs the plan data 18. For example, the processing unit 12 searches for optimum operation quantity which maximizes an profit achievable with the post-correction prediction value for demand quantity for the second period as a premise. The plan data 18 may include a plurality of operation quantities corresponding to a plurality of hours which belong to the second period. For example, the plan data 18 include a charge amount to and a discharge amount from a storage battery for twenty-four hours. The processing unit 12 may save the plan data 18 in nonvolatile storage, display the plan data 18 on a display, or transmit the plan data 18 to another information processing apparatus.

Each time operation quantity for a future period is planned, the correction model 16 may be determined. Furthermore, each time the result data 13 increase as time elapses, the correction model 16 may be corrected. In addition, the plan data 18 may be outputted to a control device which controls input and output of stock resources, such as a power control device which controls a charge to and a discharge from a storage battery. Such a control device may use the plan data 18 for controlling an input to or an output from a stock resource.

As has been described, the information processing apparatus 10 according to the first embodiment calculates the profit 14 obtained by optimizing operation quantity according to a result value of demand quantity for the first period and calculates a prediction value of demand quantity for the first period by the use of the trained prediction model 15. The information processing apparatus 10 determines the correction model 16 on the basis of a comparison between the profit 14 and the profit 17 obtained by optimizing operation quantity according to a prediction value corrected by the use of the correction model 16. The information processing apparatus 10 uses the prediction model 15 and the correction model 16 to calculate a prediction value of demand quantity for the second period, and outputs the plan data 18 indicative of operation quantity optimized according to the prediction value.

As a result, operation quantity by which a higher profit is expected is presented. Furthermore, the information processing apparatus 10 optimizes operation quantity by the use of the trained prediction model 15 and there may be no need to retrain the prediction model 15. Accordingly, computational complexity or processing time decreases. This makes optimization of operation quantity efficient and lightens the load on a user. Furthermore, a prediction value of the prediction model 15 is corrected by the correction model 16. Accordingly, a prediction value is corrected so that prediction accuracy of demand quantity with higher importance in optimizing operation quantity preferentially improves. As a result, optimization accuracy is high compared with a case where an output of the prediction model 15 is used as it is.

When the information processing apparatus 10 determines the correction model 16, the information processing apparatus 10 may search for the correction model 16 which minimizes the differential between the profit 14 and the profit 17. By doing so, the information processing apparatus 10 is able to bring an optimization result close to ideal operation quantity with no prediction error of demand quantity. Furthermore, the prediction model 15 may calculate a prediction value for each of different hours. In this connection, the correction model 16 may give different correction values according to hours. As a result, optimization accuracy of operation quantity improves for a resource having different prices according to hours. In addition, when the information processing apparatus 10 calculates the profit 14, the information processing apparatus 10 may search for operation quantity which maximizes the profit 14 with a result value indicated by the result data 13 as a premise. By doing so, the correction model 16 is determined so as to obtain an optimization result having a high possibility of maximizing a profit.

### Second Embodiment

A second embodiment will now be described.

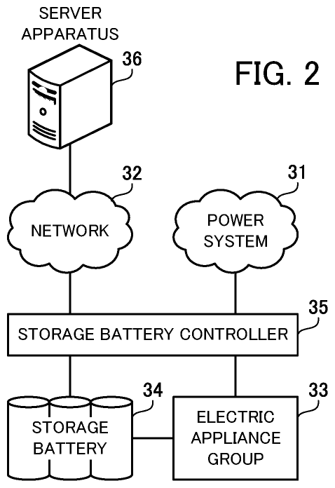

FIG. 2 illustrates an example of an information processing system according to a second embodiment.

An information processing system according to a second embodiment includes a power system 31, a network 32, an electric appliance group 33, a storage battery 34, a storage battery controller 35, and a server apparatus 36. The storage battery controller 35 and the server apparatus 36 are connected to the network 32. The server apparatus 36 corresponds to the information processing apparatus 10 according to the first embodiment.

The power system 31 is a system which generates electricity, transforms electrical energy, transmits electricity, and distribute electricity to supply power to equipment. The power system 31 is possessed by a power company. The network 32 is a data communication network. The network 32 may include a local area network (LAN) or may include a wide area network such as the Internet. Furthermore, the network 32 may include a wired network or may include a wireless network.

The electric appliance group 33 is a device group which operate by the use of electricity supplied from the power system 31. The electric appliance group 33 may be located in a house, in an office, or in the open. Electricity used by the electric appliance group 33 may be supplied directly from the power system 31 or may be once stored in the storage battery 34.

The storage battery 34 is a battery device which temporarily stores electricity supplied from the power system 31. The storage battery 34 may be located in a house, in an office, or in the open. The storage battery 34 performs charge in accordance with instructions from the storage battery controller 35 and performs discharge to the electric appliance group 33 in accordance with instructions from the storage battery controller 35.

The storage battery controller 35 is a control device which controls charge and discharge of the storage battery 34. The storage battery controller 35 may be a computer. In accordance with a charge and discharge plan inputted in advance, the storage battery controller 35 gives instructions of charge from the power system 31 to the storage battery 34 for a specific period of time and gives instructions of discharge from the storage battery 34 to the electric appliance group 33 for a specific period of time. The charge and discharge plan may be inputted from a user of the storage battery 34 or may be received from the server apparatus 36.

Usually, battery charge takes place when an electricity unit price is low among the twenty-four hours and battery discharge takes place when an electricity unit price is high among the twenty-four hours. As a result, a profit corresponding to the cost saving on electricity charge is produced. Furthermore, the storage battery controller 35 measures the hourly power consumption of the electric appliance group 33 as demand quantity and transmits measured demand quantity data to the server apparatus 36.

The server apparatus 36 is a server computer which generates, based on data received from the storage battery controller 35, a charge and discharge plan for the storage battery 34 which saves electricity costs most. The server apparatus 36 may be located in a data center or may be included in what is called a cloud system. The server apparatus 36 may output the generated charge and discharge plan to a user or may transmit the generated charge and discharge plan to the storage battery controller 35. Furthermore, a computer having the function of the server apparatus 36 may be located in a house or an office. In addition, a computer having the function of the server apparatus 36 may be a client computer.

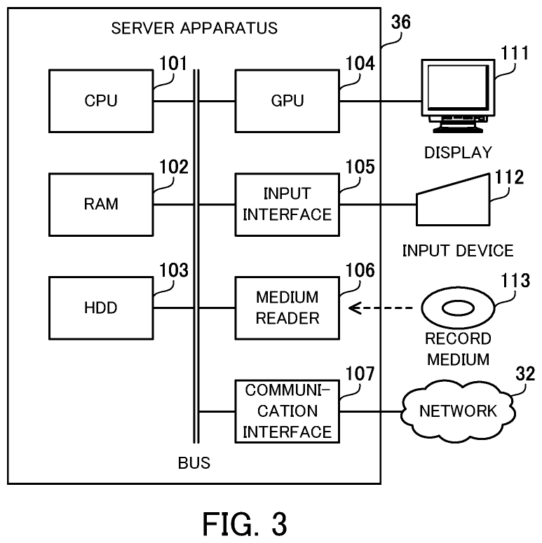

FIG. 3 is a block diagram illustrative of an example of the hardware of the sever apparatus.

The server apparatus 36 includes a CPU 101, a RAM 102, an HDD 103, a GPU 104, an input interface 105, a medium reader 106, and a communication interface 107 connected to a bus. The CPU 101 corresponds to the processing unit 12 in the first embodiment. The RAM 102 or the HDD 103 corresponds to the storage unit 11 in the first embodiment.

The CPU 101 is a processor which executes an instruction of a program. The CPU 101 loads a program and data stored in the HDD 103 into the RAM 102 and executes the program. The server apparatus 36 may include a plurality of processors.

The RAM 102 is a volatile semiconductor memory which temporarily stores a program executed by the CPU 101 and data used by the CPU 101 for performing an operation. The server apparatus 36 may include a volatile memory other than a RAM. The RAM 102 may be inserted into a RAM interface connected to the bus. Furthermore, a direct memory access (DMA) controller connected to the bus may directly transfer data between the RAM 102 and a peripheral device. In this case, data are not transferred through the CPU 101.

The HDD 103 is nonvolatile storage which stores software programs, such as an operating system (OS), middleware, and application software, and data. The server apparatus 36 may include nonvolatile storage, such as a flash memory or solid state drive (SDD), other than HDD.

The GPU 104 performs image processing in cooperation with the CPU 101 and outputs an image to a display 111 connected to the server apparatus 36. The display 111 is a cathode ray tube (CRT) display, a liquid crystal display, an organic electro luminescence (EL) display, a projector, or the like. Another output device, such as a printer, may be connected to the server apparatus 36. Furthermore, the GPU 104 may be used as a general-purpose computing on graphics processing unit (GPGPU). The GPU 104 may execute a program in accordance with instructions from the CPU 101. The server apparatus 36 may include a volatile semiconductor memory other than the RAM 102 as a GPU memory.

The input interface 105 accepts an input signal from an input device 112 connected to the server apparatus 36. The input device 112 is a mouse, a touch panel, a keyboard, or the like. A plurality of input devices may be connected to the server apparatus 36.

The medium reader 106 is a reader which reads a program and data recorded in a record medium 113. The record medium 113 is a magnetic disk, an optical disk, a semiconductor memory, or the like. The magnetic disk may be a flexible disk (FD) or HDD. The optical disk may be a compact disc (CD) or digital versatile disc (DVD). The medium reader 106 copies the program and the data read from the record medium 113 to another record medium such as the RAM 102 or the HDD 103. The read program may be executed by the CPU 101.

The record medium 113 may be a portable record medium. The record medium 113 may be used for distributing a program and data. Furthermore, the record medium 113 or the HDD 103 may be referred to as a computer-readable record medium.

The communication interface 107 communicates with the storage battery controller 35 or another information processing apparatus via a network 32. The communication interface 107 may be a wired communication interface connected to a wired communication device, such as a switch or a router, or a wireless communication interface connected to a wireless communication device, such as a base station or an access point.

Relationships among demand quantity, a unit price, and operation quantity will now be described.

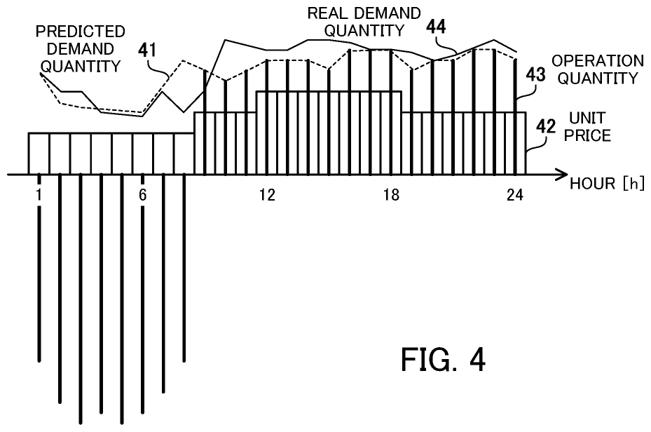

FIG. 4 is a graph illustrative of an example of an operation plan based on predicted demand quantity.

The server apparatus 36 generates an operation plan for twenty-four hours spanning from 00:00 to 24:00 as one period. The operation plan indicates operation quantity per hour. Accordingly, an operation plan for one period includes twenty-four operation quantities. Operation quantity is a charge amount to or a discharge amount from the storage battery 34. A positive operation quantity indicates a discharge amount from the storage battery 34 and negative operation quantity indicates a charge amount to the storage battery 34. Hereinafter, a value for one hour from (k−1):00 to k:00 (k=1, 2, . . . , 24) may be expressed as a value for an hour k.

An optimum operation plan which minimizes electricity cost depends on an electricity unit price at each hour and demand quantity for a target period for optimization. The electricity unit price is a meter rate portion of an electricity charge and is imposed additionally according to unit power consumption. The electricity unit price is prescribed per hour. The electricity unit prices varies among the twenty-four hours. For example, the electricity unit prices are low at midnight and in the early morning and are high in the daytime.

Demand quantity is the power consumption of the electric appliance group 33. Demand quantity is predicted or measured per hour. When an operation plan is generated, demand quantity for a future period is unknown. Accordingly, the server apparatus 36 predicts demand quantity for a future period by the use of a prediction model which is a trained machine learning model. When predicted demand quantity is calculated, the server apparatus 36 calculates optimum operation quantity for one period from the electricity unit prices and the predicted demand quantity. However, usually the predicted demand quantity and real demand quantity do not match. The real demand quantity is real power consumption of the electric appliance group 33. As a result, a profit actually obtained is often smaller than a profit expected when the operation plan is generated.

In FIG. 4, predicted demand quantity 41 is hourly demand quantity predicted by the prediction model for a day. For example, the predicted demand quantity 41 is calculated on the basis of weather forecast information such as forecast air temperature. The predicted demand quantity 41 differs among different days. A unit price 42 is an hourly electricity unit price. The unit price 42 is fixed in at least the short term and does not change according to the day.

Operation quantity 43 is operation quantity per hour determined from the predicted demand quantity 41 and the unit price 42 by optimization the server apparatus 36 performs. In general, negative operation quantity indicative of charge is calculated for hours when the unit price 42 is relatively low and positive operation quantity indicative of discharge is calculated for hours when the unit price 42 is relatively high. In order to optimize the operation quantity 43, the server apparatus 36 uses a profit corresponding to a saving amount on electricity cost as an objective function and searches for operation quantity which maximizes a value of the objective function. The saving amount on electricity cost is obtained by calculating the product of a discharge amount and the unit price 42 at each discharge hour and the product of a charge amount and the unit price 42 at each charge hour and subtracting the sum of the latter products from the sum of the former products.

In order to optimize the operation quantity 43, various optimization algorithms, such as the steepest descent method, are used. For example, the server apparatus 36 initializes the operation quantity 43 and calculates a profit for twenty-four hours from the current operation quantity 43. The server apparatus 36 calculates a profit change caused as the operation quantity 43 is changed by a very small amount at each hour, and updates the operation quantity 43 at each hour so as to increase a profit. The server apparatus 36 repeats updating the operation quantity 43 until the profit converges.

However, the operation quantity 43 does not have an arbitrary value but constraint conditions are imposed on the operation quantity 43. For example, because of the physical constraint of the storage battery 34, there is a limit to a charging speed, which is a maximum charge amount per hour, and a discharging speed, which is a maximum discharge amount per hour, and battery capacity is determined. Furthermore, the storage battery 34 does not discharge more than the power consumption of the electric appliance group 33, and the storage battery 34 does not sell electric power to the power system 31. Accordingly, the server apparatus 36 limits the operation quantity 43 for each hour to be smaller than or equal to the predicted demand quantity 41.

Real demand quantity 44 is demand quantity per hour measured after the operation plan is generated. The real demand quantity 44 depends on actual weather, an event, or the like and differs among different days. Usually, there is an error between the predicted demand quantity 41 and the real demand quantity 44. If the real demand quantity 44 for an hour with the unit price 42 high is smaller than the predicted demand quantity 41, then the storage battery 34 discharges electricity less than planned. In this case, storage loss may occur due to overcharge. Furthermore, if the real demand quantity 44 for an hour with the unit price 42 high is larger than the predicted demand quantity 41, then the deficient amount of power is purchased from the power system 31 at a high price. As a result, opportunity loss may occur. Accordingly, the accuracy of the predicted demand quantity 41 has influence on a profit obtained under the operation plan.

The above optimization of operation quantity may mathematically be prescribed in the following way. For simplifying the description, a linear regression model as indicated in expression (1) is used as a prediction model for calculating predicted demand quantity in the second embodiment. In expression (1), θ₁ and θ₂ are parameters determined by machine learning and ξ is predicted demand quantity. θ₁ is a fixed coefficient indicative of a fixed portion of the predicted demand quantity and θ₂ is a proportional coefficient indicative of a fluctuation portion proportional to air temperature. However, the prediction model may accept input data other than air temperature. Furthermore, the prediction model may use fluctuations in the latest demand quantity to predict demand quantity just after that.

ξ=θ₁+θ₂×Temperature (1)

The server apparatus 36 solves an optimization problem indicated in expression (2) by the use of an optimization algorithm. In expression (2), u is a column vector indicated in expression (3) and ξ is a column vector indicated in expression (4). u is an operation quantity vector and includes H elements. H is the number of hours included in one period and is 24 in the second embodiment. An element uₖ included in u is operation quantity for an hour k. ξ is a demand quantity vector and includes H elements. An element ξₖ included in ξ is demand quantity for the hour k. Φ(u, ξ) is a profit calculated from u and ξ. The server apparatus 36 searches for u which maximizes Φ(u, ξ) while satisfying constraint condition U.

max Φ(u,ξ)subject tou∈U (2)

u=(u₁,u₂, . . . ,u_{H})^{T} (3)

ξ=(ξ₁,ξ₂, . . . ,ξ_{H})^{T} (4)

Φ is a function indicated in expression (5). In expression (5), Pₖ is an electric unit price for the hour k. Φ calculates a profit for one period by totalizing the product of an electric unit price and operation quantity obtained for each of the H hours. U includes constraint conditions indicated in expressions (6), (7), and (8). In expression (6), −U_{c} is a charging speed of the storage battery 34 and U_{dc} is a discharging speed of the storage battery 34. Operation quantity at each hour is limited so as to be between −U_{c} and U_{dc}, inclusive. In expression (7), Uₐ is the capacity of the storage battery 34 and xₖ is a storage amount of the storage battery 34 for the hour k. A storage amount at each hour is limited so as to be smaller than or equal to Uₛ. Furthermore, as indicated in expression (8), operation quantity uₖ for the hour k is limited so as to be smaller than or equal to demand quantity ξₖ for the hour k.

$$Φ ( u , ξ ) = {\sum }_{k = 1}^{H} {P}_{k} {u}_{k} \qquad ( 5 )$$

$$- {U}_{c} \leq {u}_{k} \leq {U}_{dc} \qquad ( 6 )$$

$$0 \leq {x}_{k} \leq {U}_{s} where {x}_{k + 1} = {x}_{k} - {u}_{k} \qquad ( 7 )$$

$${u}_{k} \leq {ξ}_{k} \qquad ( 8 )$$

As stated above, predicted demand quantity and real demand quantity often differ. A prediction model is trained so that prediction errors at all hours averagely decrease. On the other hand, the influence of operation accuracy on a profit for one period differs among different hours. In general, the operation accuracy has a large influence on a profit at an hour when an electricity unit price is high and has a small influence on a profit at an hour when an electricity unit price is low. Accordingly, from the viewpoint of optimization of operation quantity, there are hours of great importance and hours of small importance. A profit is improved by preferentially increasing the accuracy of predicted demand quantity for hours of great importance.

Accordingly, in the second embodiment the server apparatus 36 does not generate an operation plan by using an output of a prediction model as it is but corrects the output of the prediction model by a correction model. When the server apparatus 36 generates an operation plan, the server apparatus 36 determines a proper correction model. However, there is no need for the server apparatus 36 to retrain the trained prediction model itself.

The functions of the server apparatus 36 will now be described.

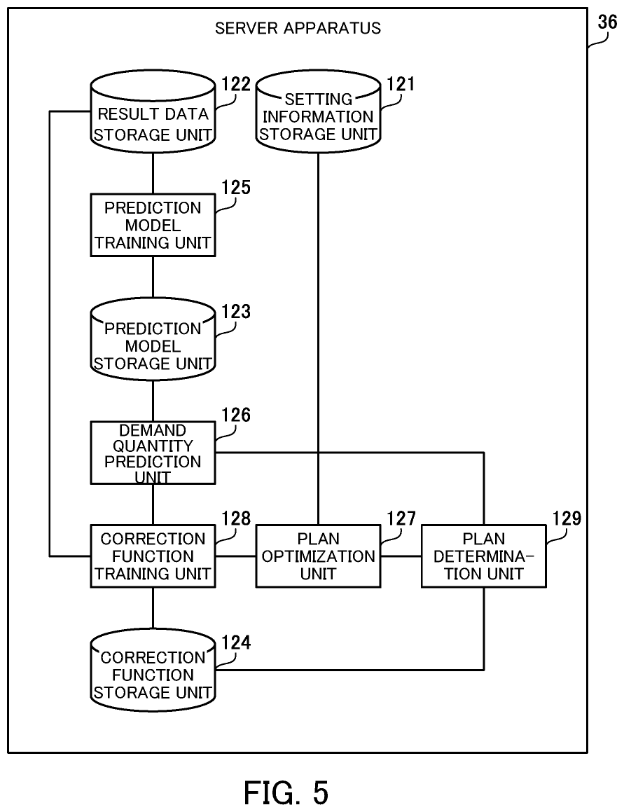

FIG. 5 is a block diagram illustrative of an example of the functions of the sever apparatus.

The server apparatus 36 includes a setting information storage unit 121, a result data storage unit 122, a prediction model storage unit 123, and a correction function storage unit 124. These storage units are implemented by the use of the RAM 102, the HDD 103, or the like. Furthermore, the server apparatus 36 includes a prediction model training unit 125, a demand quantity prediction unit 126, a plan optimization unit 127, a correction function training unit 128, and a plan determination unit 129. For example, these processing units are implemented by the use of the CPU 101 and programs.

The setting information storage unit 121 stores setting information indicative of parameters which are preconditions at the time of optimizing operation quantity. The setting information is generated by, for example, a user and is saved in the setting information storage unit 121. The setting information includes an electricity unit price per hour. Furthermore, the setting information includes the physical performance, such as the capacity, of the storage battery 34.

The result data storage unit 122 stores result data including measured values for a past period. The result data include real demand quantity per hour. For example, the real demand quantity is measured by the storage battery controller 35. Furthermore, the result data include data, such as air temperature, that is inputted to a prediction model. Some parts of the result data are used as training data and the rest are used as test data. For example, the result data include measured values for 253 days corresponding to weekdays included in July and August in the last six years. Of the measured values for the 253 days, measured values for 212 days corresponding to five years are used as training data and measured values for 41 days corresponding to one year are used as test data.

The prediction model storage unit 123 stores a prediction model trained by the use of the above result data. The prediction model predicts demand quantity. In this connection, the prediction model may be trained by another information processing apparatus. Furthermore, the prediction model may be trained by the use of training data other than the above result data. There is no need to retrain the prediction model at the time of generating an operation plan.

The correction function storage unit 124 stores a correction function trained at the time of generating the operation plan. The correction function corrects predicted demand quantity outputted by the prediction model according to hours. The demand quantity corrected by the correction function is used to generate the operation plan. The correction function may be updated each time an operation plan is generated. Alternatively, the correction function may be updated when the result data increase as time elapses.

The prediction model training unit 125 trains the prediction model by the use of the result data stored in the result data storage unit 122, and saves the trained prediction model in the prediction model storage unit 123. For example, the prediction model training unit 125 uses air temperature as a predictor variable, uses demand quantity as an objective variable, and generates a linear regression model by a least squares method.

The demand quantity prediction unit 126 predicts demand quantity for a target prediction period by inputting input data, such as air temperature, for the target prediction period to the prediction model stored in the prediction model storage unit 123. The predicted demand quantity is pre-correction demand quantity. When a correction function is trained, the demand quantity prediction unit 126 calculates predicted demand quantity for a past period and outputs it to the correction function training unit 128. Furthermore, when an operation plan for a future period is generated, the demand quantity prediction unit 126 calculates predicted demand quantity for the future period and outputs it to the plan determination unit 129.

The plan optimization unit 127 executes an optimization algorithm on the basis of the setting information stored in the setting information storage unit 121 and given demand quantity and searches for optimum operation quantity which maximizes a profit on the basis of the given demand quantity. When a correction function is trained, the plan optimization unit 127 calculates optimum operation quantity for a past period and an achievable profit and outputs them to the correction function training unit 128. Furthermore, when an operation plan for a future period is generated, the plan optimization unit 127 calculates optimum operation quantity for the future period and an achievable profit and outputs them to the plan determination unit 129.

The correction function training unit 128 trains a correction function and saves the trained correction function in the correction function storage unit 124. The correction function training unit 128 calculates an ideal profit for a past period by inputting real demand quantity included in the result data to the plan optimization unit 127. The ideal profit is a maximum profit which could be obtained for the past period if there is no prediction error of demand quantity, and may be referred to as a maximum achievable profit.

Furthermore, the correction function training unit 128 corrects, by the use of a correction function, predicted demand quantity calculated by the demand quantity prediction unit 126 for a past period and inputs the post-correction demand quantity for the past period to the plan optimization unit 127. By doing so, the correction function training unit 128 calculates a post-correction profit for the past period. The post-correction profit is a maximum profit obtained with demand quantity corrected by the use of the current correction function as a premise. The correction function training unit 128 compares the ideal profit and the post-correction profit and updates the correction function so as to decrease the differential between them. The correction function training unit 128 repeats updating a correction function until the post-correction profit converges. By doing so, the correction function training unit 128 searches for a correction function which minimizes the differential between the ideal profit and the post-correction profit.

The plan determination unit 129 corrects predicted demand quantity for a future period calculated by the demand quantity prediction unit 126 by the use of a trained correction function stored in the correction function storage unit 124 and inputs the post-correction demand quantity for the future period to the plan optimization unit 127. As a result, the plan determination unit 129 determines optimum operation quantity which maximizes a profit to be obtained with the post-correction demand quantity as a premise. The plan determination unit 129 generates and outputs an operation plan indicative of operation quantity for the future period. The plan determination unit 129 may save the operation plan in nonvolatile storage, may display the operation plan on the display 111, or may transmit the operation plan to another information processing apparatus. The plan determination unit 129 may transmit the operation plan to the storage battery controller 35.

If a correction function is tested, then the above “future period” may be replaced with a test period which is part of the past period. The plan determination unit 129 may compare pre-correction demand quantity, post-correction demand quantity, and real demand quantity for the test period. Furthermore, the plan determination unit 129 may compare a profit obtained on the basis of the pre-correction demand quantity, a profit obtained on the basis of the post-correction demand quantity, and a profit obtained on the basis of the real demand quantity. In addition, the plan determination unit 129 may save a test result of the correction function in nonvolatile storage, may display a test result of the correction function on the display 111, or may transmit a test result of the correction function to another information processing apparatus.

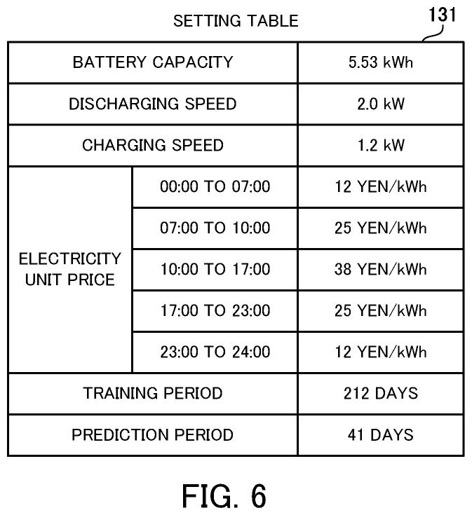

FIG. 6 illustrates an example of a setting table.

The setting information is registered in a setting table 131. The setting table 131 is stored in the setting information storage unit 121. The setting table 131 includes Battery Capacity, Discharging Speed, Charging Speed, Electricity Unit Price, Training Period, and Prediction Period. Battery Capacity is maximum electric quantity which the storage battery 34 may store. Discharging Speed is a quantity of electricity which the storage battery 34 may discharge per hour. Charging Speed is a quantity of electricity which the storage battery 34 may be charged with per hour.

Electricity Unit Price is a variable cost per unit consumed power. Electricity unit prices differ among different hours. For example, electricity unit prices are low from 00:00 to 07:00 and from 23:00 to 24:00 and are high from 07:00 to 23:00. Training Period is the number of days included in a past period for which result data are used for training a correction function. Prediction Period is the number of days included in a future period for which an operation plan is generated. However, Prediction Period may be the number of days included in a past period for which result data are used for testing a correction function, that is to say, the number of days included in a test period.

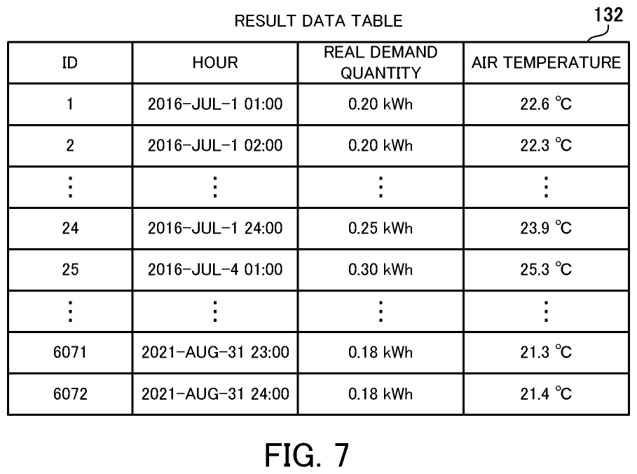

FIG. 7 illustrates an example of a result data table.

The result data are registered in a result data table 132. The result data table 132 is stored in the result data storage unit 122. A plurality of records each including ID, Hour, Real Demand Quantity, and Air Temperature are registered in the result data table 132. ID is an identification number by which a record is identified. Hour identifies a specific hour in the past. Real Demand Quantity is a measured value of power consumed by the electric appliance group 33 for an hour just before a point of time indicated by Hour. Air Temperature is outside air temperature measured at a point of time indicated by Hour. The server apparatus 36 may obtain a measured value of Air Temperature from a public institution or a weather information service company.

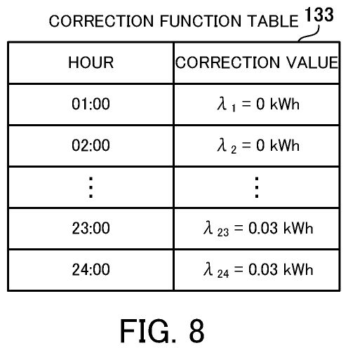

FIG. 8 illustrates an example of a correction function table.

A correction function table 133 indicates a correction function. The correction function gives to predicted demand quantity correction values which differ according to hours. The correction function table 133 is stored in the correction function storage unit 124. The correction function storage unit 124 includes twenty-four correction values corresponding to twenty-four units of hours of 01:00, 02:00, . . . and 24:00 included in one period. A correction value may be positive or negative. The server apparatus 36 calculates post-correction demand quantity for an hour k (k=1, 2, . . . , 24) by adding a correction value λₖ for the hour k to predicted demand quantity for the hour k. However, the correction function indicated in the correction function table 133 is an example. The structure of a correction function is not limited to this.

Training a correction function may mathematically be prescribed in the following way. The correction function training unit 128 generates an ideal operation plan as indicated in expression (9) from result data for a past period. In expression (9), ξ^{D} is a column vector indicative of real demand quantity for one period and u* is a column vector indicative of ideal operation quantity for the one period. u* indicates operation quantity for the one period optimized so as to maximize a profit with the real demand quantity as a premise. Accordingly, Φ(u*, ξ^{D}) indicates an ideal profit which is a maximum profit obtained on the basis of the real demand quantity.

u*=argmax Φ(u,ξ^{D}) (9)

Result data used for training the correction function include real demand quantity for N periods (N is an integer greater than or equal to 2), that is to say, for N days in the past. For example, N=212. Generating the ideal operation plan and calculating the ideal profit are performed in units of twenty-four hours. Accordingly, as indicated in expression (10), the correction function training unit 128 calculates N ideal profits corresponding to the N periods.

Φ(u₁*,ξ₁^{D}),Φ(u₂*,ξ₂^{D}), . . . ,Φ(u_{N}*,ξ_{N}^{D}) (10)

As indicated in expression (11), the correction function training unit 128 corrects predicted demand quantity outputted by a prediction model by the use of a correction function. In expression (11), is a column vector including H predicted demand quantities outputted by the prediction model and A is a column vector including H correction values. The correction function training unit 128 adds λ to ξ. Accordingly, the correction function training unit 128 adds a correction value λₖ for the hour k to predicted demand quantity k for the hour k. A is used in common over the N periods.

ξ+λ=(ξ₁+λ₁,ξ₂+λ₂, . . . ,ξ_{H}+λ_{H})^{T} (11)

As indicated in expression (12), the correction function training unit 128 generates a post-correction operation plan from post-correction demand quantity. In expression (12), u** is a column vector indicative of post-correction operation quantity for one period. u** indicates operation quantity for the one period optimized so as to maximize a profit with the post-correction demand quantity as a premise. Accordingly, Φ(u**, ξ+λ) indicates a post-correction profit which is a maximum profit which may be obtained on the basis of the post-correction demand quantity. Generating the post-correction operation plan and calculating the post-correction profit are performed in units of twenty-four hours. Accordingly, the post-correction profit Φ(u**, ξ+λ) is calculated for each of the N periods. This is the same with the ideal profit Φ(u*, ξ^{D}).

u**=argmax Φ(u,ξ+λ) (12)

As indicated in expression (13), the correction function training unit 128 searches for a correction value which minimizes the differential between the post-correction profit and the ideal profit. The correction function training unit 128 subtracts the ideal profit from the post-correction profit for each of the N periods. The correction function training unit 128 totalizes subtraction results for the N periods and calculates the absolute value of the value obtained. Alternatively, the correction function training unit 128 may totalize the post-correction profits for the N periods, totalize the ideal profits for the N periods, subtract the latter result from the former result, and calculate the absolute value of the value obtained. The correction function training unit 128 searches for A which minimizes the differential between the post-correction profit and the ideal profit.

$$min \vert {\sum }_{i = 1}^{N} ( Φ ( {u}_{i}^{**} , {ξ}_{i} + λ ) - Φ ( {u}_{i}^{*} , {ξ}_{i}^{D} ) ) \vert \qquad ( 13 )$$

If the steepest descent method is used, then, as indicated in expression (14), the correction function training unit 128 calculates a gradient for each of H hours. In expression (14), βₖ is the gradient of the post-correction profit to the predicted demand quantity ξₖ at an hour k. βₖ indicates how the total of the N post-correction profits fluctuates as the predicted demand quantity ξₖ is changed by a very small amount.

$${β}_{k} = \frac{\partial }{\partial {ξ}_{k}} {\sum }_{i = 1}^{N} Φ ( {u}_{i}^{**} , {ξ}_{i} + λ ) \qquad ( 14 )$$

The correction function training unit 128 compares the total of the N post-correction profits and the total of the N ideal profits. If the total of the N post-correction profits is smaller than the total of the N ideal profits, then, as indicated in expression (15), the correction function training unit 128 updates the correction value for each of the H hours. In expression (15), η is a constant indicative of a learning rate. η is set to a sufficiently small value on the basis of a step method. The correction function training unit 128 calculates a correction value for the current iteration by adding η times the gradient βₖ for the hour k to a correction value for the hour k in the previous iteration.

$${λ}_{k} = {λ}_{k} + {ηβ}_{k} if {\sum }_{i = 1}^{N} Φ ( {u}_{i}^{**} , {ξ}_{i} + λ ) < {\sum }_{i = 1}^{N} Φ ( {u}_{i}^{*} , {ξ}_{i}^{D} ) \qquad ( 15 )$$

On the other hand, if the total of the N post-correction profits is larger than the total of the N ideal profits, then, as indicated in expression (16), the correction function training unit 128 updates the correction value for each of the H hours. The correction function training unit 128 calculates a correction value for the current iteration by subtracting η times the gradient βₖ for the hour k from a correction value for the hour k in the previous iteration.

$${λ}_{k} = {λ}_{k} - {ηβ}_{k} if {\sum }_{i = 1}^{N} Φ ( {u}_{i}^{**} , {ξ}_{i} + λ ) > {\sum }_{i = 1}^{N} Φ ( {u}_{i}^{*} , {ξ}_{i}^{D} ) \qquad ( 16 )$$

The correction function training unit 128 repeats iteration for calculating a gradient and updating a correction value until a convergence condition is satisfied. The convergence condition is satisfied when a post-correction profit converges. When the correction function training unit 128 updates a correction value, the correction function training unit 128 compares the total of the post-correction profits for the N periods for the previous iteration with the total of the post-correction profits for the N periods for the current iteration. The correction function training unit 128 subtracts the total of the post-correction profits for the N periods for the current iteration from the total of the post-correction profits for the N periods for the previous iteration, calculates the absolute value of the value obtained, and determines whether or not the calculated differential is smaller than a threshold E. If the calculated differential is smaller than the threshold c, then the correction function training unit 128 stops iteration and determines a correction function.

A procedure for a process performed by the server apparatus 36 will now be described.

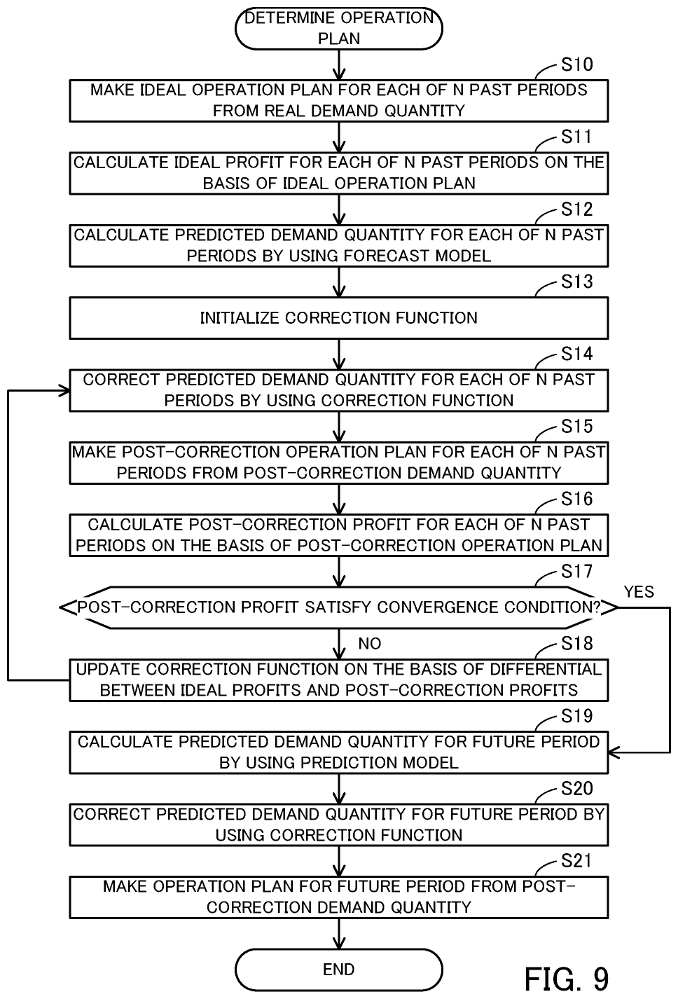

FIG. 9 is a flow chart illustrative of an example of a procedure for determining an operation plan.

(Step S10) On the basis of real demand quantity, the plan optimization unit 127 generates, for each of N past periods, an ideal operation plan in which operation quantity is optimized so as to maximize a profit.

(Step S11) The plan optimization unit 127 calculates, for each of the N past periods, an ideal profit expected to obtain by the ideal operation plan generated in step S10. However, the ideal profit may already be calculated in a search performed in step S10.

(Step S12) The demand quantity prediction unit 126 calculates predicted demand quantity for each of the N past periods by inputting input data, such as air temperature, to a trained prediction model.

(Step S13) The correction function training unit 128 initializes a correction function.

(Step S14) The correction function training unit 128 corrects the predicted demand quantity for each of the N past periods calculated in step S12 by the use of the correction function.

(Step S15) On the basis of post-correction demand quantity, the plan optimization unit 127 generates, for each of the N past periods, a post-correction operation plan in which operation quantity is optimized so as to maximize a profit.

(Step S16) The plan optimization unit 127 calculates, for each of the N past periods, a post-correction profit expected to obtain by the post-correction operation plan generated in step S15. However, the post-correction profit may already be calculated in a search performed in step S15.

(Step S17) The correction function training unit 128 determines whether or not the post-correction profit calculated in step S16 satisfies a convergence condition. For example, the correction function training unit 128 compares the total of the post-correction profits for the N past periods for the previous iteration with the total of the post-correction profits for the N past periods for the current iteration and determines whether or not the differential between the previous iteration and the current iteration is smaller than a threshold value. If the post-correction profit calculated in step S16 satisfies the convergence condition, then the process proceeds to step S19. If the post-correction profit calculated in step S16 does not satisfy the convergence condition, then the process proceeds to step S18.

(Step S18) The correction function training unit 128 compares the total of the ideal profits for the N past periods with the total of the post-correction profits for the N past periods and updates the correction function so as to decrease the differential between them. For example, the correction function training unit 128 calculates a gradient for each of H hours and updates each of H correction values by the use of the gradient according to a magnitude relationship between the total of the ideal profits for the N past periods and the total of the post-correction profits for the N past periods. Then, the process returns to step S14.

(Step S19) The demand quantity prediction unit 126 calculates predicted demand quantity for a future period by inputting input data, such as air temperature, to the trained prediction model.

(Step S20) The plan determination unit 129 corrects the predicted demand quantity for the future period calculated in step S19 by the use of the trained correction function.

(Step S21) On the basis of post-correction demand quantity, the plan optimization unit 127 generates, for the future period, an operation plan in which operation quantity is optimized so as to maximize a profit. The plan determination unit 129 outputs the operation plan.

A comparison among real demand quantity, predicted demand quantity, and post-correction demand quantity will now be described.

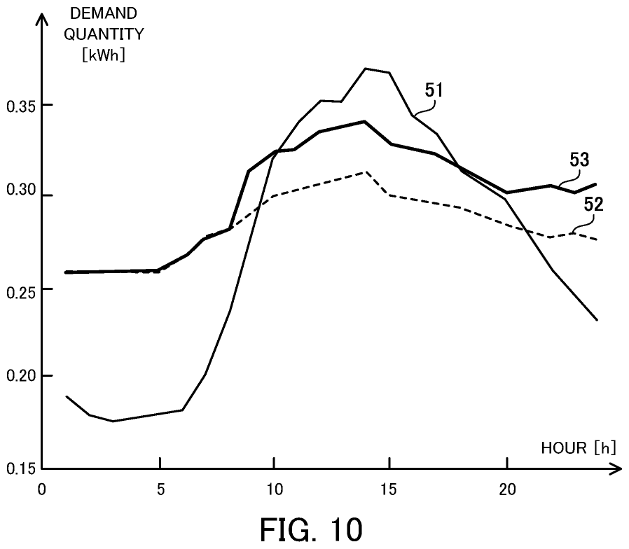

FIG. 10 is a graph illustrative of an example of a comparison between real demand quantity and predicted demand quantity.

Curve 51 indicates real demand quantity for twenty-four hours included in a test period. Curve 52 indicates predicted demand quantity for the twenty-four hours included in the test period outputted by a prediction model. Curve 53 indicates post-correction demand quantity for the twenty-four hours included in the test period corrected by a correction function. The post-correction demand quantity is closer to the real demand quantity than the predicted demand quantity for hours when electricity unit prices are high and which are more important in optimizing operation quantity. That is to say, a prediction error is small.

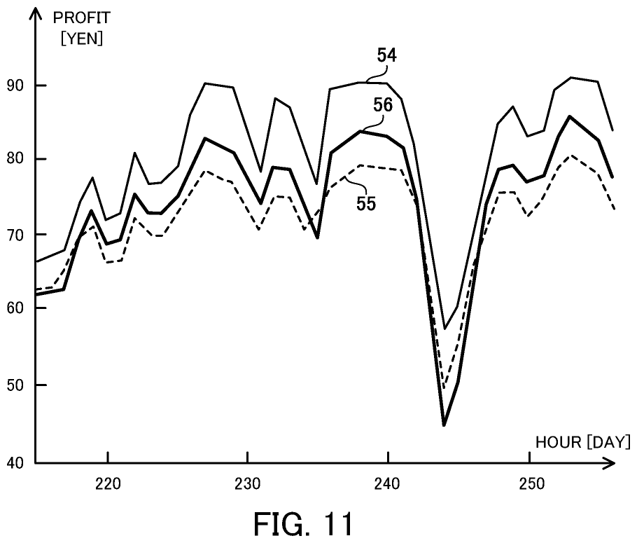

FIG. 11 is a graph illustrative of an example of a comparison between an ideal profit and a predicted profit.

Each of curves 54, 55, 56 indicates a daily profit for a test period. Curve 54 indicates a profit obtained if an operation plan optimized ex post facto on the basis of real demand quantity is carried out. Curve 55 indicates a profit obtained if an operation plan optimized on the basis of predicted demand quantity is carried out under the real demand quantity. Curve 56 indicates a profit obtained if an operation plan optimized on the basis of post-correction demand quantity is carried out under the real demand quantity. The prediction accuracy of the post-correction demand quantity is high for hours of importance, compared with that of the predicted demand quantity outputted by a prediction model. As a result, the accuracy of an operation plan which is an optimization result improves. Accordingly, a profit realized by executing the operation plan generated from the post-correction demand quantity is higher than a profit realized by executing the operation plan generated from the predicted demand quantity.

As has been described, the server apparatus 36 in the second embodiment generates an operation plan which controls charge and discharge of the storage battery 34 so that a profit corresponding to a saving amount on electricity cost increases. As a result, useful information is provided to a user. Furthermore, the server apparatus 36 generates an operation plan by the use of a trained prediction model and there is no need to retrain a prediction model. This decreases computational complexity or processing time and makes optimization efficient. In addition, there is no need for a user to comprehend complex internal structure of the prediction model. This reduces the load on the user who makes an operation plan.

Moreover, the server apparatus 36 trains a correction model used for correcting an output of the prediction model on the basis of result data for a past period and generates an operation plan by the use of not only the prediction model but also the correction model. At this time, the server apparatus 36 trains the correction model so as to decrease the differential between an ideal profit achievable if real demand quantity is known and a profit expected on the basis of predicted demand quantity. As a result, the predicted demand quantity is corrected so that prediction accuracy for hours which are important for an operation plan preferentially increases, and a high-quality operation plan by which a high profit is obtained is generated.

According to an aspect, it is possible to improve efficiency of optimization of operation quantity using a prediction value of a machine learning model.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A non-transitory computer-readable recording medium storing a computer program that causes a computer to execute a process comprising:
calculating, based on result data indicative of a result value for a first demand quantity which arises for a first period, a first profit obtained by optimizing an operation quantity according to the result value;
calculating a first prediction value for the first demand quantity by using a prediction model that has been trained;
determining, based on a comparison between the first profit and a second profit obtained by optimizing the operation quantity according to a second prediction value obtained by correcting the first prediction value with a correction model, the correction model; and
calculating a third prediction value for a second demand quantity which arises for a second period different from the first period by using the prediction model that has been trained and the correction model and outputting plan data indicative of the operation quantity optimized according to the third prediction value.

2. The non-transitory computer-readable recording medium according to claim 1, wherein the determining includes searching for the correction model which minimizes a differential between the first profit and the second profit.

3. The non-transitory computer-readable recording medium according to claim 1, wherein:
the prediction model calculates the first prediction value for each of different hours; and
the correction model assigns different correction values to the different hours.

4. The non-transitory computer-readable recording medium according to claim 1, wherein the calculating of the first profit includes searching, based on the result value, for the operation quantity which maximizes the first profit.

5. An optimization method comprising:
calculating, by a processor, based on result data indicative of a result value for a first demand quantity which arises for a first period, a first profit obtained by optimizing an operation quantity according to the result value;
calculating, by the processor, a first prediction value for the first demand quantity by using a prediction model that has been trained;
determining, by the processor, based on a comparison between the first profit and a second profit obtained by optimizing the operation quantity according to a second prediction value obtained by correcting the first prediction value with a correction model, the correction model; and
calculating, by the processor, a third prediction value for a second demand quantity which arises for a second period different from the first period by using the prediction model that has been trained and the correction model and outputting, by the processor, plan data indicative of the operation quantity optimized according to the third prediction value.

6. An information processing apparatus comprising:
a memory configured to store result data indicative of a result value for a first demand quantity which arises for a first period; and
a processor coupled to the memory and the processor configured to:
calculate, based on the result data, a first profit obtained by optimizing an operation quantity according to the result value;
calculate a first prediction value for the first demand quantity by using a prediction model that has been trained;
determine, based on a comparison between the first profit and a second profit obtained by optimizing the operation quantity according to a second prediction value obtained by correcting the first prediction value with a correction model, the correction model; and
calculate a third prediction value for a second demand quantity that arises for a second period different from the first period by using the prediction model that has been trained and the correction model and output plan data indicative of the operation quantity optimized according to the third prediction value.
